(19) United States
(12) Patent Application Publication
(10) Pub. No.: US 2026/0212368 A1
(43) Pub. Date: Jul. 23, 2026

(54) Method for attesting a mobile terminal for implementing a payment application on the mobile terminal

(71) Applicant: BANKS AND ACQUIRERS INTERNATIONAL HOLDING, SURESNES (FR)

(72) Inventor: Jérome GRANDEMENGE, PARIS (FR)

(21) Appl. No.: 19/141,804

(22) PCT Filed: Dec. 22, 2023
(86) PCT No.: PCT/EP2023/087652

§ 371 Date: Jun. 20, 2025

(30) Foreign Application Priority Data
Dec. 22, 2022 (FR) FR2214210

(51) Int. Cl. G06Q 20/40; G06F 21/44; G06F 21/57; G06Q 20/32

(52) U.S. Cl. CPC G06Q 20/409; G06F 21/44; G06F 21/577; G06Q 20/326

(57) ABSTRACT

A method for attesting a mobile terminal for implementing a payment application on the mobile terminal. The mobile terminal is configured to communicate with a server. The method is implemented by the mobile terminal and includes: issuing to the server a request to establish a trusted communication channel; receiving an attestation request from the server, the attestation request being randomly selected by the server from a predetermined subset of a plurality of attestation requests, the attestation request defining a list of characteristics of the mobile terminal; collecting a list of values for the mobile terminal, a value of the list of values corresponding to a characteristic of the list of characteristics of the mobile terminal transmitted by the server; and transmitting to the server the list of values, the trusted communication channel being established by the server according to the list of values.

### CROSS-REFERENCE TO RELATED APPLICATIONS

This Application is a Section 371 National Stage Application of International Application No. PCT/EP2023/087652, filed Dec. 22, 2023, and published as WO 2024/133904 A1 on Jun. 27, 2024, not in English, which claims priority to and the benefit of French Patent Application No. FR 2214210, filed Dec. 22, 2022, the contents of which are incorporated herein by reference in their entireties.

### FIELD OF THE DISCLOSURE

The present invention concerns the field of payment applications, and in particular software applications configured to transform a commercial mobile terminal intended for the general public into a payment terminal.

### BACKGROUND OF THE DISCLOSURE

It is known to use a software application to transform a commercial mobile terminal intended for non-professional customers, for example, a smart phone, in particular a smartphone type, into a payment terminal. Said software application implements a method configured to guarantee the confidentiality of payment transactions carried out by the mobile terminal.

This can only be authorized if the commercial mobile terminal meets security criteria. However, the mobile terminal cannot determine on its own that it meets the security criteria. A specific method implemented by a server is required to attest that the mobile terminal meets the criteria.

The payment card industry specifications do not describe how to develop and implement such an attestation method.

It is known to obtain the desired attestation from a set of information concerning the mobile terminal, with the information being transferred «in bulk» to the server.

However, this attestation method consumes a lot of processing power in the mobile terminal and requires a lot of time to collect and transfer the data to the server.

### SUMMARY

The invention therefore aims to provide a solution to all or part of these problems.

To this end, the present invention concerns a method for attesting a mobile terminal for implementing a payment application on the mobile terminal, the mobile terminal being configured to communicate with a server, the method comprising the following steps implemented by the mobile terminal:
receiving an attestation request from the server, the attestation request being randomly selected by the server from a predetermined subset of a plurality of attestation requests, the attestation request defining a list of characteristics of the mobile terminal,
collecting a list of values for the mobile terminal, a value in the list of values corresponding to a characteristic in the list of characteristics of the mobile terminal transmitted by the server;
transmitting the list of values to the server,
the trusted communication channel being established by the server based on the list of values.

According to these provisions, since the server randomly selecting a limited number of attestation requests from a large number of possible attestation requests, it is very difficult for an attacker to design a mechanism to fraudulently determine the responses expected by the server. The random nature of the selection, from all possible lists of technical characteristics, of one list or another of the mobile terminal's technical characteristics thus provides protection against a «man-in-the-middle» attack.

According to these provisions, the method allows the establishment of a trusted communication channel that is implemented for a transaction phase that uses the trusted communication channel thus established, for example, for said transaction, such as a payment procedure.

According to one embodiment, the invention comprises one or more of the following characteristics, alone or in a technically acceptable combination.

According to one embodiment, the attestation request is encrypted by the server using a variable encryption key selected from a set of encryption keys of the server, each encryption key in the set of encryption keys corresponding to a decryption key of the mobile terminal, the decryption key being stored in a white box of the mobile terminal, and the method further comprises a step of decrypting the encrypted attestation request with the decryption key of the mobile terminal stored in the white box of the mobile terminal.

According to one embodiment, the method further comprises a step of encrypting the list of values with another variable encryption key of the mobile terminal stored in a white box of the mobile terminal, the encryption step producing a list of encrypted values, the list of values transmitted to the server during the transmission step being the list of encrypted values.

According to one embodiment, the established trusted communication channel is secure.

According to one embodiment, the list of characteristics of the mobile terminal comprises at least one among at least one of the characteristics of the mobile terminal among a brand, a model number, and a version number of an operating system of the mobile terminal.

According to one embodiment, the mobile terminal is a commercial device intended for the general public, for example of a smart phone type, in particular a smartphone, or a tablet.

According to one embodiment, the method further comprises the following steps, implemented after the establishment of the trusted communication channel:
receiving another attestation request from the server, the other attestation request being randomly selected by the server among the plurality of attestation requests, the other attestation request defining another list of characteristics of the mobile terminal;
collecting another list of values for the mobile terminal, a value from the other list of values corresponding to a characteristic from the other list of characteristics of the mobile terminal;
another transmission to the server of the other list of values;
the communication channel being maintained or interrupted by the server depending on the other list of values.

According to these provisions, since the number of attestation requests included in the plurality of attestation requests is large, each individual request may concern a small amount of information; the collection and transmission of this information by the mobile terminal will thus require limited computing power and workload. It should be noted that another attestation request from the predetermined subset of the plurality of attestation requests defines another list of characteristics of the mobile terminal.

According to one implementation, the step of receiving another attestation request takes place at a time depending on a time randomly determined by the server.

According to these provisions, the server randomly selecting a small number of attestation requests from a large number of possible attestation requests, and the server issuing these requests at randomly determined times, makes it even more difficult for an attacker to design a fraudulent mechanism for determining the responses expected by the server.

According to one embodiment, the other attestation request is encrypted by the server using an encryption key of the server corresponding to a decryption key of the mobile terminal, the decryption key being stored in a white box of the mobile terminal, and the method further comprises a step of decrypting the other encrypted attestation request with the decryption key of the mobile terminal stored in the white box of the mobile terminal.

According to one embodiment, the method further comprises a step of encrypting the other list of values with another variable encryption key of the mobile terminal stored in a white box of the mobile terminal, the encryption step producing another list of encrypted values, the other list of values transmitted to the server during the other transmission being the other list of encrypted values.

According to one embodiment, the list of characteristics of the mobile terminal comprises at least one of the following characteristics: presence or absence of a specific software module among the applications installed on the mobile terminal, brand of the mobile terminal, identification number of the mobile terminal, version of the operating system installed on the mobile terminal, presence or absence of a determined file in the file system installed on the mobile terminal.

According to one aspect, the invention also concerns a method for attesting a mobile terminal for implementing a payment application on the mobile terminal, the mobile terminal being configured to communicate with a server, the method comprising the following steps implemented by the server:
transmitting to the mobile terminal an attestation request, the attestation request being randomly selected by the server from a predetermined subset of a plurality of attestation requests, the attestation request defining a list of characteristics of the mobile terminal;
receiving a list of values, a value from the list of values corresponding to a characteristic from the list of characteristics of the mobile terminal transmitted by the server;
determining, based on the list of values, a security level of the mobile terminal;
establishing a trusted communication channel based on the security level of the mobile terminal.

According to these provisions, the server randomly selecting a limited number of attestation requests from a large number of possible attestation requests, making it very difficult for an attacker to design a mechanism for fraudulently determining the responses expected by the server.

According to one embodiment, the invention comprises one or more of the following characteristics, alone or in a technically acceptable combination.

According to one embodiment, the method comprises a transaction phase that can use the trusted communication channel established by the method, for example to implement a payment procedure.

According to one embodiment, the method further comprises a step of encryption by the server, using a variable encryption key, selected from a set of encryption keys of the server, each encryption key of the set of encryption keys corresponding to a decryption key of the mobile terminal, the decryption key being recorded in a white box of the mobile terminal, the encrypted attestation request being decrypted with the decryption key of the mobile terminal recorded in the white box of the mobile terminal.

According to one embodiment, the method further comprises a step of decrypting the list of encrypted values by the server, using another server decryption key corresponding to a variable encryption key of the mobile terminal stored in a white box of the mobile terminal, the decryption step producing the list of values.

According to one embodiment, the trusted communication channel is established based on the security level of the mobile terminal and based on a delay between the reception of the list of values and the transmission of the attestation request.

According to one embodiment, if the reception delay is greater than a determined delay, or if the security level is lower than a determined threshold, the communication channel is not established by the server.

According to one embodiment, the method further comprises the following steps, implemented by the server after establishing the communication channel:
transmitting at least one other attestation request, the at least one other attestation request being randomly selected by the server among the plurality of attestation requests;
receiving another list of values, a value from the other list of values corresponding to a characteristic of the other list of characteristics of the mobile terminal;
another step of determining, based on the other list of values, another security level of the mobile terminal;
maintaining or interrupting the trusted communication channel depending on the other security level.

According to these provisions, since the number of attestation requests included in the plurality of attestation requests is large, each individual request may concern a small amount of information; the collection and transmission of this information by the mobile terminal will thus require limited computing power and load.

According to one implementation, the step of transmitting at least one other attestation request takes place at a time randomly determined by the server.

According to these provisions, the server randomly selecting a limited number of attestation requests among a large number of possible attestation requests, and the server issuing these requests at randomly determined times, making it even more difficult for an attacker to design a mechanism for fraudulently determining the responses expected by the server.

According to one implementation, the other attestation request is encrypted by the server using a server encryption key corresponding to a decryption key of the mobile terminal, the decryption key being recorded in a white box of the mobile terminal.

According to one embodiment, the method further comprises a step of decryption by the server of the other list of encrypted values, with another server decryption key corresponding to a variable encryption key of the mobile terminal stored in a white box of the mobile terminal, the decryption step producing the other list of values.

According to one embodiment, the communication channel is established based on the other security level of the mobile terminal and based on another delay between the reception of the other list of values and the transmission of the other attestation request.

According to another aspect, the invention relates to a computer program comprising a set of instructions configured to implement the method according to one of the embodiments described above, when the instructions are executed on a processor of a mobile terminal, or the method according to one of the other embodiments described above, when the instructions are executed on a processor of a server.

According to another aspect, the invention relates to a mobile terminal comprising a processor and a memory and a set of instructions recorded in the memory, the set of instructions being configured to implement the method according to the embodiments described above when the instructions are executed on the processor of the mobile terminal.

### BRIEF DESCRIPTION OF THE DRAWINGS

For a better understanding, an embodiment and/or implementation of the invention is described with reference to the attached drawings representing, by way of non-limiting example, an embodiment or implementation respectively of a device and/or a method according to the invention. The same references in the drawings designate similar elements or elements with similar functions.

FIG. 1 is a schematic representation of the sequence of steps of the method according to one embodiment of the invention.

FIG. 2 is a schematic representation of a mobile terminal configured for an implementation of the invention.

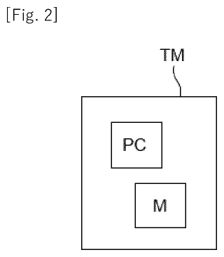

### DETAILED DESCRIPTION

The invention concerns a method 100, 200 for attesting a commercial mobile terminal TM, intended for non-professional clients, for example a smart phone, in particular a smartphone type, the attestation of the mobile terminal TM being performed by a server S, with a view to establishing a trusted communication channel between the mobile terminal TM and the server S, for the execution of a payment, when certain attestation conditions relating to the mobile terminal TM are met.

The trusted communication channel established when the attestation conditions are met may be, for example, a trusted and secure communication channel, in other words, a communication channel between two mutually authenticated points whose communication is protected confidentially. A secure communication channel makes it possible, in particular, to guarantee the authenticity and origin of the key, and thus to be protected against an attack known as a «man-in-the-middle» attack.

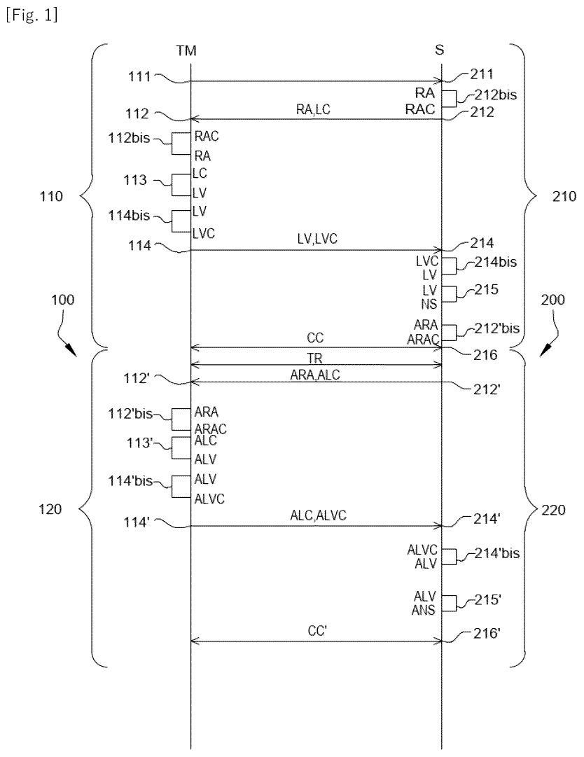

The steps of the attestation method 100, 200 according to the invention are described below, with reference to FIG. 1, by successively considering the steps of the method 100 implemented by the mobile terminal TM, presented from top to bottom along a vertical line TM in FIG. 1, and the steps of the method 200 implemented by the server S, presented from top to bottom along a vertical line S in FIG. 1; the steps of the method 100 and method 200 together contribute to the attestation of the mobile terminal TM for the execution of a payment.

The method particularly comprises a phase 110, 210 of establishing a trusted communication channel between the mobile terminal TM and the server S, intended to be used during a transaction TR phase 120, 220 that uses the trusted communication channel CC, CC′ established and/or maintained by the server, to execute the transaction TR associated with the execution of the payment. The communication channel will be designated by the reference CC when it is the established trusted communication channel, and will be designated by the reference CC′ when it is the same established and maintained trusted communication channel.

The establishment phase 110, 210 begins more specifically with a request step 111 of establishing a communication channel sent by the mobile terminal TM to the server; upon receipt 211 by the server S of the request 111, the server S transmits 212 to the mobile terminal TM an attestation request RA, the attestation request being randomly selected by the server S from a predetermined subset of a plurality of attestation requests, the attestation request defining a list of characteristics LC of the mobile terminal TM. Thus, a relatively small number of attestation requests RA is randomly selected from a large number of possible attestation requests, such that it will be difficult for a fraudster to design the responses required for the selected attestation requests RA, by listening to the responses made to previous attestation requests.

The following steps, implemented by the mobile terminal TM, are a step 112 of receiving the attestation request RA from the server S, followed by a step 113 of collecting the information required by the attestation request RA; this collection leads to the creation of a list of values LV for the mobile terminal TM, a value from the list of values LV corresponding to a characteristic of the list of characteristics LC of the mobile terminal TM transmitted by the server S; in other words, each characteristic of the list of characteristics LC can take a certain number of specific values for the mobile terminal TM in question, such that the latter collects, during the collection step, the specific value corresponding to a given characteristic of the list of characteristics LC.

For example, the list of characteristics LC will comprise at least one of the following characteristics: presence or absence of a determined software module among the applications installed on the mobile terminal, brand of the mobile terminal, identification number of the mobile terminal, for example, a serial number of the mobile terminal, version of the operating system installed on the mobile terminal, presence or absence of a determined file in the file system installed on the mobile terminal. For each of these characteristics, the mobile terminal TM will collect a specific value of its own, so as to create a list of values LV.

The next step, implemented by the mobile terminal TM, is a step of transmitting 114 the list of values LV to the server S.

The following steps, implemented by the server S, are respectively the steps of:
receiving 214 the list of values LV;
determining 215, based on the list of values LV, of a security level NS of the mobile terminal TM;
establishing 216 the trusted communication channel CC based on the security level NS of the mobile terminal TM.

Thus, the security level is determined 215 based, for example, on one or more of the following characteristic values:
presence or absence of a specific software module among the applications installed on the mobile terminal,
brand of the mobile terminal,
identification number of the mobile terminal,
version of the operating system installed on the mobile terminal,
presence or absence of a specific file in the file system installed on the mobile terminal.

For example, the determined security level is compared to a predetermined level: if the determined security level is higher than the predetermined level, then the trusted communication channel CC is established 216 between the server S and the mobile terminal TM. Otherwise, it is not established by the server S.

The trusted communication channel CC, as established at the end of step 216 of establishing the trusted communication channel CC, may in particular be further secured, within the meaning of the definition recalled above.

Thus, the method 100, 200 may in particular, during a transaction TR phase 120, 220, use the trusted communication channel CC established 216 by the server S, in particular to implement a payment procedure.

According to an exemplary implementation, the exchanges during the establishment phase 110, 210 may be encrypted to achieve an enhanced security; thus, according to this exemplary implementation, the attestation request RA is encrypted 212bis by the server S using a variable encryption key, selected from a set of encryption keys of the server S, each encryption key of the set of encryption keys corresponding to a decryption key of the mobile terminal TM, the decryption key being recorded in a white box of the mobile terminal TM, and the method 100 further comprises a step of decrypting 112bis the encrypted attestation request RAC with the decryption key of the mobile terminal TM recorded in the white box of the mobile terminal TM.

According to an additional example of implementation, the method 100 further comprises a step of encryption 114bis of the list of values LV with another variable encryption key of the mobile terminal TM recorded in a white box of the mobile terminal TM, the encryption step 114bis producing a list of encrypted values LVC, the list of values transmitted to the server S during the transmission step 114 being the list of encrypted values LVC. Conversely, according to this exemplary implementation, the method 200 further comprises a step of decryption 214bis by the server S of the list of encrypted values LVC, with another server decryption key S corresponding to a variable encryption key of the mobile terminal TM stored in a white box of the mobile terminal TM, the decryption step 214bis producing the list of values LV.

Optionally, the method 100 may further comprise, after the establishment 216 by the server S of the trusted communication channel CC, and in particular during the transaction phase 120, 220 TR which uses the trusted communication channel, the following steps of:
receiving 112′ one or more other attestation requests ARA from the server S, each other attestation request ARA being randomly selected by the server S among the plurality of attestation requests, each other attestation request defining another ALC characteristic list of the mobile terminal TM;
collecting 113′ another list of values ALV for the mobile terminal TM, a value from the other list of values ALV corresponding to a characteristic from the other ALC characteristic list of the mobile terminal TM;
transmitting 114′ to the server S of the other list of values ALV;
the communication channel CC′ being maintained or interrupted 216′ by the server S depending on the other list of values ALV.

Similarly, from the point of view of the server S, the corresponding steps of the method 200 are implemented by the server:
transmitting 212′ one or more other attestation requests ARA;
receiving 214′ one or more other lists of values ALV, each other list of values corresponding to one of the other attestation requests ARA;
determining 215′, on the basis of each other list of values ALV, another security level ANS of the mobile terminal TM;
maintaining or interrupting the communication channel CC′ depending on the other security level ANS.

Thus, since the number of attestation requests included in the plurality of attestation requests is large, each individual request may concern a small amount of information; the collection and transmission of this information by the mobile terminal will therefore require limited computing power and load.

In particular, the step 212′ of transmitting by the server the other attestation request ARA takes place at a time randomly determined by the server S, during an exchange of messages between the mobile terminal TM and the server S which uses the trusted communication channel CC, so that the step 112′ of receiving by the mobile terminal TM of the other attestation request ARA takes place at a time depending on the time randomly determined by the server S (the time of reception 112′ of the other attestation request by the mobile terminal TM is in fact a function of the time of transmission 212′ of said other request by the server S, the time of transmission 212′ by the server S being randomly determined by the server S). The mechanism for issuing one (or more) other attestation requests ARA is thus «intertwined» with the functional dialogue between the mobile terminal TM and the server S, which uses the trusted communication channel CC, in particular for a phase 120, 220 of implementing a transaction TR.

According to these provisions, the server randomly selecting a limited number of attestation requests from a large number of possible attestation requests, and the server issuing these requests at randomly determined times, making it even more difficult for an attacker to design a mechanism for fraudulently determining the responses expected by the server.

According to an additional implementation example of the method 100, 200, the trusted communication channel CC is established based on the security level NS of the mobile terminal TM and based on a delay between the reception 214 of the list of values LV and the transmission 212 of the attestation request; Thus, for example, if the reception delay is greater than a determined delay, or if the security level NS is lower than a determined threshold, the trusted communication channel CC is not established by the server S; similarly, the trusted communication channel is maintained or interrupted 216′ by the server S depending on the other security level ANS of the mobile terminal TM and depending on another delay between the reception 214′ of the other list of values ALV and the transmission 212′ of the other attestation request ARA, among the plurality of other attestation requests that the server S is likely to issue after the establishment of the trusted channel CC, in particular during the phase 120, 220 of implementing a transaction TR.

In the same way that the information exchanges can be encrypted during the establishment phase 110, 220, before the establishment 216 of the trusted communication channel CC by the server S, the information exchanges after the establishment 216 of the trusted communication channel CC by the server S, with a view to maintaining or interrupting 216′ the communication channel CC′ by the server S, may also be encrypted. Thus, according to an implementation example, the other attestation request ARA is encrypted 212′bis by the server S using an encryption key of the server S corresponding to a decryption key of the mobile terminal TM, the decryption key being stored in a white box of the mobile terminal TM, and the other encrypted attestation request ARAC is decrypted 112′bis with the decryption key of the mobile terminal TM recorded in the white box of the mobile terminal TM.

Similarly, the method 100 may further comprise a step 114′bis of encrypting the other list of values ALV with another variable encryption key of the mobile terminal TM recorded in a white box of the mobile terminal TM, the encryption step 114′bis producing another list of encrypted values ALVC, transmitted to the server S during the other transmission 114′; conversely, the method 200 further comprises a decryption step 214′bis by the server S of the other list of encrypted values ALVC, with another server decryption key S corresponding to the variable encryption key of the mobile terminal TM, the decryption step 214bis producing the other list of values ALV.

According to one aspect, the invention concerns a computer program comprising a set of instructions configured to implement the method 100, according to one of the embodiments described above, when the instructions are executed on a processor of a mobile terminal TM, or the method 200 according to one of the embodiments described above, when the instructions are executed on a processor of a server S.

According to another aspect, the invention concerns a mobile terminal TM comprising a processor PC and a memory M and a set of instructions recorded in the memory M, the set of instructions being configured to implement the method 100 according to one of the embodiments described above when the instructions are executed on the processor of the mobile terminal TM.

Although the present disclosure has been described with reference to one or more examples, workers skilled in the art will recognize that changes may be made in form and detail without departing from the scope of the disclosure and/or the appended claims.

1. A method for attesting a mobile terminal for implementing a payment application on the mobile terminal, the mobile terminal being configured to communicate with a server, the method being implemented by the mobile terminal and comprising:
receiving an attestation request from the server, the attestation request being randomly selected by the server from a predetermined subset of a plurality of attestation requests, the attestation request defining a list of characteristics of the mobile terminal;
collecting a list of values for the mobile terminal, a value of the list of values corresponding to a characteristic of the list of characteristics of the mobile terminal transmitted by the server;
transmitting the list of values to the server; and
establishing a trusted communication channel with the server the trusted communication channel being based on the list of values and a security level of the mobile terminal determined by the server on the basis of the list of values.

2. The method according to claim 1, wherein the established trusted communication channel is secure.

3. The method according to claim 1, further comprising the following, implemented after the establishment of the trusted communication channel:
reception of another attestation request from the server the other attestation request being randomly selected by the server among the plurality of attestation requests, the other attestation request defining another list of characteristics of the mobile terminal;
collection of another list of values for the mobile terminal, a value of the other list of values corresponding to a characteristic of the other list of characteristics of the mobile terminal;
another transmission to the server of the other list of values;
the communication channel being maintained or interrupted by the server depending on the other list of values.

4. The method according to claim 3, wherein the receiving another attestation request takes place at a time depending on a time randomly determined by the server.

5. A method for attesting a mobile terminal for implementing a payment application on the mobile terminal, the mobile terminal being configured to communicate with a server, the method being implemented by the server and comprising:
transmission to the mobile terminal of an attestation request, the attestation request being randomly selected by the server from a predetermined subset of a plurality of attestation requests, the attestation request defining a list of characteristics of the mobile terminal;
reception of a list of values, a value of the list of values corresponding to a characteristic of the list of characteristics of the mobile terminal transmitted by the server;
determination of, on the basis of the list of values, a security level of the mobile terminal; and
establishment of a trusted communication channel based on the security level of the mobile terminal.

6. The method according to claim 5, wherein the trusted communication channel is established according to the security level of the mobile terminal and according to a delay between the reception of the list of values and the transmission of the attestation request.

7. The method according to claim 6, further comprising the following, implemented by the server after the establishment of the communication channel:
transmission of at least one other attestation request the at least one other attestation request being randomly selected by the server among the plurality of attestation requests;
reception of another list of values a value from the other list of values corresponding to a characteristic from the other list of characteristics of the mobile terminal;
another determining, based on the other list of values another security level of the mobile terminal; and
maintaining or interrupting the trusted communication channel depending on the other security level.

8. The method according to claim 7, wherein the transmitting at least one other attestation request takes place at a time randomly determined by the server.

9. The method according to claim 7, wherein the communication channel is established according to the other security level of the mobile terminal and according to another delay between the reception of the other list of values and the transmission of the other attestation request.

10. non-transitory computer readable medium comprising a computer program stored thereon comprising a set of instructions configured to implement the method according to claim 1 when the instructions are executed on a processor of a the mobile terminal.

11. A mobile terminal comprising:
at least one processor; and
at least one memory storing a set of instructions the set of instructions being configured to implement a method for attesting a mobile terminal for implementing a payment application on the mobile terminal, when the instructions are executed on the at least one processor of the mobile terminal-(TM), the mobile terminal being configured to communicate with a server, the method comprising:
receiving an attestation request from the server, the attestation request being randomly selected by the server from a predetermined subset of a plurality of attestation requests, the attestation request defining a list of characteristics of the mobile terminal;
collecting a list of values for the mobile terminal, a value of the list of values corresponding to a characteristic of the list of characteristics of the mobile terminal transmitted by the server;
transmitting the list of values to the server; and
establishing a trusted communication channel with the server, the trusted communication channel being based on the list of values and a security level of the mobile terminal determined by the server on the basis of the list of values.

12. A non-transitory computer readable medium comprising a computer program stored thereon comprising a set of instructions configured to implement the method according to claim 5 when the instructions are executed on a processor of the server.
